(19) United States
(12) Patent Application Publication
(10) Pub. No.: US 2022/0154513 A1
(43) Pub. Date: May 19, 2022

(54) DOOR CONTROL DEVICE

(71) Applicant: TOYOTA JIDOSHA KABUSHIKI KAISHA, Toyota-shi (JP)

(72) Inventors: Masaho ISHIDA, Toyota-shi (JP); Noriyuki SAITOH, Nisshin-shi (JP)

(73) Assignee: TOYOTA JIDOSHA KABUSHIKI KAISHA, Toyota-shi (JP)

(21) Appl. No.: 17/478,170

(22) Filed: Sep. 17, 2021

(30) Foreign Application Priority Data
Nov. 19, 2020 (JP) 2020-192550

(51) Int. Cl. E05F 15/611; E05F 15/42; E05F 15/73

(52) U.S. Cl. CPC E05F 15/611; E05F 15/42; E05F 2015/483; E05Y 2900/531; E05Y 2400/54; E05F 15/73

(57) ABSTRACT

A door control device includes: a sensor device that acquires target information; a door operation unit operated by an occupant; an actuator that changes a door from a closed state to an open state; and a control unit that drives the actuator to change the door from the closed state to the open state. When it is determined that an obstruction is not detected at an operation detection point of time when operation of the door operation unit is detected while the vehicle is stationary, and when it is determined that the obstruction is detected during a period from an operation start point of time of the door operation unit to a point of time when operation continuation time reaches a first time, the control unit keeps the door in the closed state regardless of the operation continuation time.

### CROSS-REFERENCE TO RELATED APPLICATION

This application claims priority to Japanese Patent Application No. 2020-192550 filed on Nov. 19, 2020, incorporated herein by reference in its entirety.

### BACKGROUND

### 1. Technical Field

The present disclosure relates to a door control device capable of switching the state of a vehicle door.

### 2. Description of Related Art

Conventionally, door control devices have been known which execute getting-off support control that is configured to, for example, keep a vehicle door in a locked state, when an obstruction that may hinder safe getting-off action of an occupant of a vehicle is detected while the vehicle is stationary. When the getting-off support control is executed, the door is not open even though an occupant operates a door operation unit (for example, a switch or an inside handle) provided inside the vehicle. Therefore, it is possible to reduce the possibility of the door or the occupant touching the obstruction.

When the door is constantly in a locked state during the period of time when an obstruction is detected in a vehicle equipped with such a door control device, an occupant is unable to get off even in the situation where the occupant desires to get off by paying careful attention to the surrounding. Accordingly, in the case where a prescribed operation is performed on a door operation unit, the locked state of the door is canceled and switched to an unlocked state or an opened state even when an obstruction is detected.

Japanese Unexamined Patent Application Publication No. 2017-122350 discloses a vehicle door lock device. In the case where a door is held in a locked state under getting-off support control, the vehicle lock device forcibly switches the door to an unlocked state when an occupant touches an inside handle twice as the prescribed operation.

### SUMMARY

Incidentally, a mechanism is known which detects operation of a door operation unit and opens and closes a door based on a detected signal. For example, there is known a mechanism (so-called opening and closing mechanism using a power sliding door) that detects operation of a switch provided in the vicinity (typically a pillar) of each door inside the vehicle and slides each door based on a detected signal so as to open and close each door. The mechanism for opening and closing the doors based on an electrical signal is adopted mainly for sliding doors at present, but in recent years it is being considered to apply the mechanism to non-sliding doors (for example, swing-type doors). Here, the swing-type doors refer to a type of doors fixed by hinges. The doors are pivoted with the hinges as pivoting axis so as to be opened and closed.

Vehicles to which the above door opening and closing mechanism are applied may be configured to open a door when operation of a door operation unit (for example, pressing operation of a switch) is continued for a prescribed first time (for example, 0.7 seconds) in order to reduce the possibility that the door opens because the door operation unit is unintentionally operated by baggage or occupants in the vehicles. In the case of mounting the door control device on such vehicles, it is considered to define the prescribed operation (the operation performed by an occupant who desires to get off even when an obstruction is detected) as “continuing the operation of the door control unit for a prescribed second time (e.g., 3 seconds) that is longer than the first time.” According to the configuration, when an obstruction is detected, the door does not open when the occupant continues the operation of the door operation unit for the first time, whereas when the occupant continues the operation of the door operation unit for the second time, the doors opens. This makes it possible to reduce the possibility of the occupant opening the door without noticing an obstruction, and allows the occupant to get off at a desired time after recognizing the obstruction.

In such vehicles, there is a case where no obstruction is detected at a point of time when an occupant starts to operate the door operation unit, though an obstruction is detected by the time that the first time elapses. In this case, when the door is opened at the point of time when the first time elapses, the occupant may fail to get off safely.

Accordingly, the door control device may be configured to open the door when, for example, the door operation unit is continuously operated until the second time elapses from the point of time when an obstruction is detected.

According to the configuration, the occupant can recognize the obstruction and then get off the vehicle, so that the safety at the time of getting off the vehicle is expected to be enhanced. However, “the period from a point of time when the occupant starts to operate the door operation unit (also referred to as “operation start point of time”) to a point of time when the door opens” varies. Hence, there are possibilities that the occupant feels discomfort. Specifically, when an obstruction is detected, for example, at the point of time when 0.5 seconds elapses from the operation start point of time (during the period until the first time elapses), the occupant continues to operate the door operation unit for a total of 3.5 seconds because the door opens when the operation of the door operation unit continues for 3 seconds (second time) from the detection point of time. The duration of time for continuing the operation differs depending on at which point of time the obstruction is detected during the period from the operation start point of time to the point of time when the first time elapses. Moreover, the duration of time for continuing the operation is always longer than the second time. When the period of time from the operation start point of time to the door opening time varies in this way, an occupant fails to sense how long does it take from the time that the occupant starts to operate the door operation unit to the time that the door opens. Therefore, the occupant may feel discomfort.

The present disclosure has been made in order to cope with the above issue. Specifically, an object of the present disclosure is to provide a door control device capable of reducing the possibilities that an occupant feels discomfort when the occupant opens a door of a vehicle while the vehicle is stationary.

A door control device according to the present disclosure (hereinafter referred to as “device of the present disclosure”) includes a sensor device, a door operation unit, an actuator, and a control unit. The sensor device is configured to acquire information about a target that is present around a vehicle as target information. The door operation unit is disposed inside the vehicle and configured to be operated by an occupant of the vehicle when the occupant changes a door of the vehicle from a closed state to an open state. The actuator is configured to be able to change the door of the vehicle from the closed state to the open state. The control unit is configured to drive the actuator in accordance with the target information and an operation state of the door operation unit to change the door from the closed state to the open state. The control unit is configured to determine, based on the target information, whether or not an obstruction that may hinder safe getting-off action of the occupant is detected. When it is determined that the obstruction is not detected at a point of time when operation of the door operation unit is detected while the vehicle is stationary, and when it is not determined that the obstruction is detected during a first period from an operation start point of time of the door operation unit to a first point of time when operation continuation time that is time for continuing the operation reaches a prescribed first time, the control unit drives the actuator such that the door is kept in the closed state until the first point of time, and the door is changed from the closed state to the open state at the first point of time. When it is determined that the obstruction is detected during the first period, the control unit is configured to keep the door in the closed state regardless of the operation continuation time. When it is determined that the obstruction is detected at the point of time when operation of the door operation unit is detected while the vehicle is stationary, the control unit is configured to drive the actuator such that the door is kept in the closed state during a second period from an operation start point of time of the door operation unit to a second point of time when the operation continuation time reaches a second time that is longer than the first time, and the door is changed from the closed state to the open state at the second point of time.

In the device of the present disclosure, when no obstruction is detected at the point of time when the operation of the door operation unit is detected (in other words, at the operation start point of time of the door operation unit), though an obstruction is detected during the first period until a first point of time at which the operation continuation time reaches the first time, the door (strictly speaking, the door corresponding to the operated door operation unit) is kept in the closed state (the door does not open) regardless of the operation continuation time. Therefore “the period from an operation detection point of time of the door operation unit to the point of time when the door opens” no longer varies. This makes it possible to reduce the possibilities that the occupant feels discomfort when opening the door while the vehicle is stationary.

In one aspect of the present disclosure, the sensor device may be configured to acquire information about a target approaching from a rear lateral side of the vehicle and a target present on a lateral side of the vehicle as the target information.

With the configuration, it is possible to reduce the possibilities that the door or the occupant comes into contact with a target approaching from the rear lateral side of the vehicle and a target present on the lateral side of the vehicle when the occupant gets off the vehicle.

In the above description, in order to facilitate understanding of the present disclosure, the component members of the disclosure corresponding to an embodiment are affixed with reference signs used in the embodiment in parentheses. However, each of the component members of the present disclosure is not limited to the embodiment defined by the reference signs.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic block diagram of a door control device according to an embodiment of the present disclosure;

FIG. 2 shows a detection range of each sensor device included in the door control device;

FIG. 3 is a flowchart showing a timer routine executed by a CPU of a getting-off support ECU of the door control device;

FIG. 4 is a flowchart showing an operation change flag routine executed by the CPU; and

FIG. 5 is a flowchart showing a door opening control routine executed by the CPU.

### DETAILED DESCRIPTION OF EMBODIMENTS

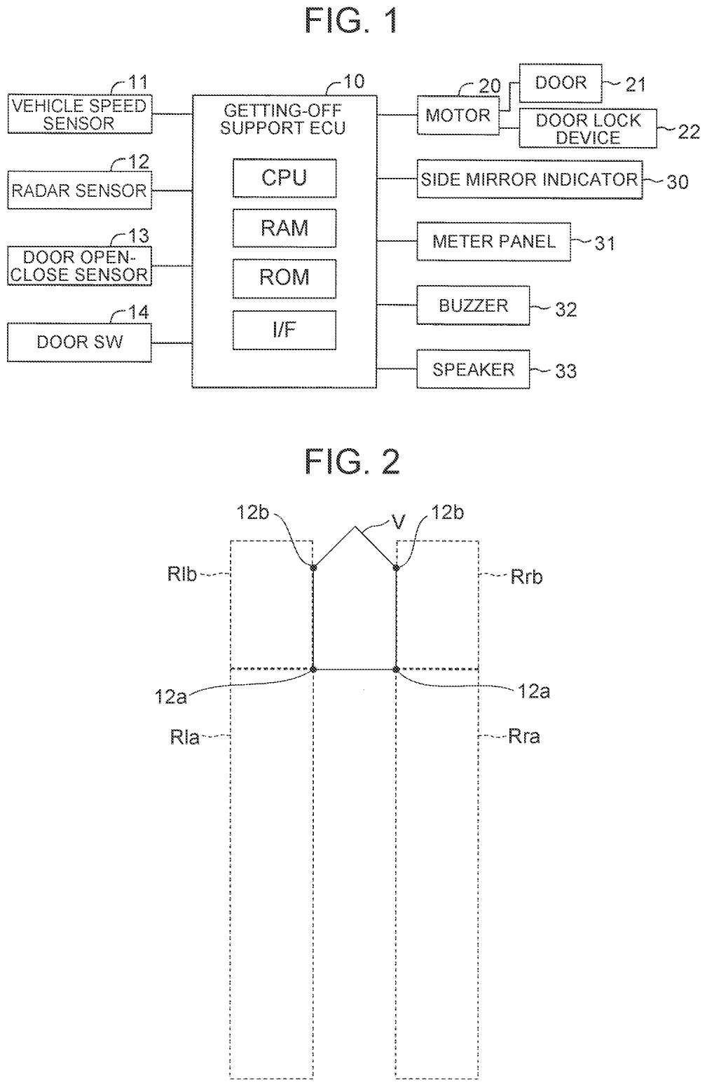

Hereinafter, a door control device according to an embodiment of the present disclosure (hereinafter also referred to as “device of the present embodiment”) will be described with reference to the drawings. As shown in FIG. 1, the device of the present embodiment includes a getting-off support ECU 10. The getting-off support ECU 10 includes a microcomputer as its main component. The ECU stands for electronic control unit. The microcomputer includes components such as a CPU, a ROM, a RAM and an interface (IF). The CPU implements various functions by executing instructions (programs, routines) stored in the ROM. In the following description, a vehicle mounted with the device of the present embodiment is referred to as an “own vehicle”.

The getting-off support ECU 10 is connected to a vehicle speed sensor 11, radar sensors 12, door open-close sensors 13, door switches (door SW) 14, motors 20, side mirror indicators 30, a meter panel 31, a buzzer 32 and a speaker 33. The getting-off support ECU 10 is configured to acquire detection signals of the sensors and switches 11 to 14 whenever a prescribed time elapses, and control the motors 20 and the elements (devices) 30 to 33 based on the detection signals. Hereinafter, the getting-off support ECU 10 is also simply referred to as “ECU 10”.

The vehicle speed sensor 11 generates a signal corresponding to travel speed of the own vehicle (hereinafter referred to as “vehicle speed”). The ECU 10 acquires the signal generated by the vehicle speed sensor 11 and calculates a vehicle speed based on the signal. When the vehicle speed is zero, the ECU 10 determines that the own vehicle is in a stopped state (also referred to as “being stationary”).

The radar sensors 12 have a function to acquire information about a solid objects that are present around the own vehicle. The solid objects include moving objects (such as vehicles, pedestrians, and bicycles that are traveling) and stationary objects (such as stationary vehicles, guardrails, and street trees).

As shown in FIG. 2, the radar sensors 12 include first radar sensors 12a and second radar sensors 12b. The first radar sensors 12a are provided at a left rear corner and a right rear corner of an own vehicle V, respectively. The second radar sensors 12b are provided below the left and right front lamps (illustration omitted) of the own vehicle, respectively. Hereinafter, the first radar sensors 12a and the second radar sensors 12b are referred to as “radar sensors 12” unless they are required to be distinguished from each other.

The radar sensors 12 irradiate the circumference of the own vehicle with electric waves in millimeter wave bands. Specifically, the first radar sensor 12a on the left side irradiates a range including a first left side region Rla on a rear lateral side of the own vehicle with electric waves, and the first radar sensor 12a on the right side irradiates a range including a first right side region Rra on a rear lateral side of the own vehicle with electric waves. The second radar sensor 12b on the left side irradiates a range including a second left side region Rlb on a lateral side of the own vehicle with electric waves, and the second radar sensors 12b on the right side also irradiates a range including a second right side region Rrb on a lateral side of the own vehicle with electric waves. The radar sensors 12 may not include the second radar sensors 12b. In that case, the first radar sensors 12a may desirably be configured to be able to irradiate the ranges including the regions Rla, Rra, as well as the ranges including the regions Rlb, Rrb with electric waves.

When solid objects are present in electric wave irradiation ranges, the radar sensors 12 receive reflected waves from the solid objects. Based on irradiation timing and reception timing of the electric waves, the radar sensors 12 calculate the presence or absence of solid objects, relative relationship between the own vehicle and the solid objects (distance from the own vehicle to the solid objects, direction of the solid objects relative to the own vehicle, and speed of the solid objects relative to the own vehicle). In other words, the radar sensors 12 detect solid objects that are present around the own vehicle. The radar sensors 12 transmit to the ECU 10 information about the solid objects present in the regions Rla, Rra, Rib, Rrb as target information.

The first radar sensors 12a may irradiate the rear side as well as the rear lateral side of the own vehicle with electric waves. In addition, sensors used for blind spot monitor control may be used as the first radar sensors 12a. The blind spot monitor control is a control that alerts the driver of the own vehicle when a vehicle approaching the own vehicle from behind (a vehicle present in a region that is difficult to recognize with side mirrors in particular) is detected.

Furthermore, the ECU 10 may be connected to camera sensors not illustrated. The camera sensors pick up landscape images of the regions Rla, Rra, Rlb, Rrb, and, based on the picked up image data, calculate information about the presence or absence of a solid object and information indicating relative relationship between the own vehicle and the solid object as “information about solid object”. The camera sensors transmit to the ECU 10 information about the solid objects as target information. The ECU 10 may merge the target information from the radar sensors 12 with the target information from the camera sensors to detect an obstruction described later.

Back to FIG. 1, the description will be continued. The door open-close sensor 13 is provided in each of four doors 21 included in the own vehicle. The doors 21 are swing-type doors including a front right door, a rear right door, a front left door, and a rear left door. The door open-close sensor 13 detects the open and closed state of each of the doors 21. When the doors 21 are open, the door open-close sensors 13 generate an open signal indicating that the doors 21 are open. When the doors 21 are closed, the door open-close sensors 13 generate a close signal indicating that the doors 21 are closed. The ECU 10 can detect which signal, the open signal or the close signal, the respective door open-close sensors 13 generate. Based on the result of detection, the ECU 10 can detect whether the doors 21 corresponding to their respective door open-close sensors 13 are in an open state or a closed state (i.e., the open-closed states of that doors).

The door SWs 14 are provided inside the own vehicle (hereafter referred to as “in the vehicle”). Specifically, the door SWs 14 are provided at prescribed positions of the respective doors 21 (for example, in the vicinity of electric window switches). The door SWs 14 can be pressed by an occupant of the own vehicle. When the door SWs 14 are pressed, they each generate an ON signal to indicate that the door SWs 14 are pressed (i.e., in an ON state). When the door SWs 14 are not pressed, they each generate an OFF signal to indicate that the door SWs 14 are not pressed (i.e., in an OFF state). The ECU 10 can detect which signal, the On signal or the OFF signal, the respective door SWs 14 generate. Based on the result of detection, the ECU 10 can detect whether the door SWs 14 are in the ON state or the OFF state. The door SWs 14 correspond to an example of the “door operation unit”.

The motors 20 are incorporated in the doors 21, respectively. The motors 20 are connected to door lock devices 22. The door lock devices 22 are known devices that each switch the corresponding door 21 between locked and unlocked states. Typically, the door lock devices 22 each have a latch (illustration omitted) and a striker (illustration omitted). The latch is provided in each of the doors 21. The striker is provided in each of door opening parts so as to correspond to each latch. The door lock devices 22 each lock the corresponding door 21 (switch the corresponding door 21 to a locked state) through engagement of the latch and the striker. The door lock device 22 each unlock the corresponding door 21 (switch the corresponding door 21 to an unlocked state) through disengagement of the latch and the striker.

The motors 20 are configured to be able to maintain or cancel the engagement between the latch and the striker in the corresponding door lock devices 22. In other words, the motors 20 are each configured to be able to switch the states of the corresponding door 21 between the locked state and the unlocked state. In addition, the motors 20 are each configured to be able to open and close the corresponding door 21. Specifically, when the door 21 is in the unlocked state, the corresponding motor 20 can cancel the engagement between the door 21 and the door opening part to open the door 21. In the present embodiment, “the motor 20 is driven to open the door 21” refers to that the door 21 is opened to the extent that a gap is generated between the door 21 and the door opening part. When an occupant pushes the door 21 from the inside of the vehicle in this state, the door 21 is further opened by pivoting with a hinge as a pivot axis, so that the occupant can get off. Hereinafter, the state that the door 21 is open to the extent that a gap is generated between the door 21 and the door opening part is also referred to as “open state”.

On the other hand, the motor 20 can engage the corresponding door 21 with the door opening part to close the door 21, when the door 21 is in the open state.

Hereinafter, the state that the door 21 is closed (in other words, the state that the door opening part is completely blocked by the door 21) is also referred to as “closed state”. The closed state includes the locked state and the unlocked state. The aspect that the motor 20 opens the door 21 is not limited to the above example. For example, the motor 20 may be configured to drive the hinge of the corresponding door 21 to open the door 21 to the extent that an occupant can get off

When the own vehicle is stationary, the ECU 10 drives the motor 20 based on signals from the door open-close sensor 13 and door SW 14, and thereby controls the door lock device 22 to switch the door 21 between the locked state and the unlocked state or to switch the corresponding door 21 between the open state and the closed state.

Specific operation to switch the door 21 between the open and closed states will be described. When the door 21 is in the locked state, the ECU 10 drives the motor 20 to cancel the engagement of the door lock device 22 and switch the door 21 to the unlocked state. Then, the ECU 10 drives the motor 20 to cancel the engagement between the door 21 and the door opening part so as to switch the door 21 from the closed state to the open state. When the door 21 is in the unlocked state, the ECU 10 cancels the engagement between the door 21 and the door opening part by driving the motor 20 so as to switch the door 21 from the closed state to the open state.

On the other hand, when a prescribed door closing condition is satisfied while the door 21 is in the open state, the ECU 10 drives the motor 20 to engage the door 21 with the door opening part to switch the door 21 from the open state to the closed state. Then, the ECU 10 drives the motor 20 to engage the door lock device 22 so as to switch the door 21 from the unlocked state to the locked state.

The side mirror indicators 30 are provided at prescribed positions in the left and right side mirrors of the own vehicle. The side mirror indicators 30 can be switched on and off independently of each other. The meter panel 31 is provided in the front of a driver's seat of the own vehicle (at a position that is visible to the driver). The buzzer 32 is incorporated in the meter panel 31. The speaker 33 is a component member of a navigation system (illustration omitted). The speaker 33 is provided in the vicinity of a touch screen display which is not illustrated.

Operation

When the own vehicle is stationary and a given door 21 is in the closed state, the ECU10 determines whether or not there is “an obstruction that may hinder safe getting-off action of an occupant involving opening of the door 21” based on target information acquired from the radar sensors 12. The method of determining whether or not an obstruction is present (i.e. whether or not an obstruction is detected) will be described later. When the own vehicle is stationary, and the door 21 is closed, the ECU10 operates as described below, based on whether an obstruction is present or not and the state of the door SW 14. Hereinafter, a point of time when an occupant starts to press the door SW 14 is referred to as “pressing start point of time” and a duration of the time when the door SW 14 continues to be pressed is referred to as “pressing continuation time T”. Furthermore, to simplify the description, unless otherwise specified, the door 21 signifies a specific door or doors, the door SW 14 signifies a door SW or SWs corresponding to the specific door or doors, and the obstruction signifies an obstruction to the specific door or doors.

(1) When the obstruction is detected while the door SW 14 is not pressed:

In this case, the ECU 10 keeps the door 21 in the closed state, and lights the side mirror indicator 30 on the side where the obstruction is detected. Specifically, when the obstruction is detected in the first left side region Rla or the second left side region Rib, the ECU 10 keeps the left side doors 21 (left front door and left rear door) in the closed state, and lights the left side mirror indicator 30. When the obstruction is detected in the first or second right side regions Rra, Rrb, the ECU 10 keeps the right side doors 21 (right front door and right rear door) in the closed state, and lights the right side mirror indicator 30.

This control is performed at all times while the obstruction is detected.

(2) When the obstruction is not detected at the pressing start point of time (2A) When the obstruction is not detected during a period (first period) from the pressing start point of time to the first point of time when the pressing continuation time T reaches the first time T1 (0.7 seconds in present embodiment):

In this case, the ECU 10 keeps the door 21 in the closed state until the first point of time, and switches the door 21 from the closed state to the open state at the first point of time. In other words, even when there is no obstruction at all, the ECU 10 does not switch the door 21 from the closed state to the open state as soon as the door SW 14 is pressed. In this case, when the operation to press the door SW14 for the pressing continuation time T that reaches the first time T1 (so-called long pressing operation over the first time T1) is detected, the ECU 10 switches the door 21 from the closed state to the open state. This makes it possible to reduce the possibilities that the door 21 opens when the door SW 14 is unintentionally pressed for a short period of time by luggage, occupants, or luggage and occupants inside the vehicle.

(2B) When the obstruction is detected during the period (first period) from the pressing start point of time to the first point of time when the pressing continuation time T reaches the first time T1:

In this case, the ECU 10 keeps the door 21 in the closed state regardless of the pressing continuation time T, and does not switch the door 21 to the open state. In other words, after the point of time when the obstruction is detected, the ECU 10 does not switch the door 21 from the closed state to the open state, unless the door SW14 is changed to an OFF state and then is operated again to an ON state. In short, the ECU 10 ignores this pressing operation of the door SW 14.

Further in this case, the ECU 10 alerts the occupant at the point of time when the obstruction is detected. Specifically, when the door SW 14 is pressed while the obstruction is detected, the ECU 10 flashes the side mirror indicator 30 on the side where the obstruction is detected for a predetermined period of time (for example, 2 seconds) after the point of time of pressing, displays a prescribed mark (for example, a mark indicating a relative position of the obstruction in relation to the own vehicle) on the meter panel 31 for a prescribed time (for example, 3 seconds), and activates the buzzer 32 for a predetermined period of time (for example, 300 milliseconds).

(3) When the obstruction is detected at the pressing start point of time:

In this case, the ECU 10 keeps the door 21 in the closed state during a period (second period) from the pressing start point of time to a second point of time when the pressing continuation time T reaches a “second time T2 (3 seconds in the present embodiment) that is longer than the first time T1”, and switches the door 21 from the closed state to the open state at the second point of time. Specifically, when the obstruction is detected at the pressing start point of time, the ECU 10 switches the door 21 from the closed state to the open state at the second point of time, even in the case where the obstruction is no longer detected during the period until the second point of time when the pressing continuation time T reaches the second time T2 or in the case where the obstruction continues to be detected over the entire period.

Further in this case, the ECU 10 alerts the occupant at the pressing start point of time. Specifically, while the obstruction is detected and the door SW 14 is pressed, the ECU 10 flashes the side mirror indicator 30 on the side where the obstruction is detected, displays the mark on the meter panel 31, and activates the buzzer 32. In addition, at the pressing start point of time, the ECU 10 controls the speaker 33 to speak a prescribed message (e.g., “be aware of approaching vehicle”) only once.

In the case (2B), if the door 21 is configured to open when the door SW 14 continues to be pressed (further) for the second time T2 after the point of time when the obstruction is detected, “the period from the pressing start point of time to the point of time when the door 21 opens” may vary, and therefore the occupant may feel discomfort. Contrary to this, in the case (2B), the device of the present embodiment is configured not to open the door 21 regardless of the pressing continuation time T of the door SW 14 (in other words, even when the pressing continuation time T reaches the second time T2). Therefore, “the period from the pressing start point of time to the point of time when the door 21 opens” no longer varies, which makes is possible to reduce the possibilities that the occupant feels discomfort. When the occupant desires to get off by paying careful attention to the surroundings in the case (2B), the occupant may temporarily stop pressing the door SW 14 and then presses again. When the obstruction is detected at the point of time when the door SW 14 is pressed again, the door 21 is switched to the open state at the second point of time when the pressing continuation time T reaches the second time T2.

Method Of Detecting Obstruction

Description is now given of a method of detecting an obstruction. When a solid object is present in the first left side region Rla shown in FIG. 2, the ECU 10 calculates time to collision (TTC), which is estimated time taken for the solid object to collide or approach most to the own vehicle. More specifically, the TTC is defined as the time taken for the solid object to cross “virtual line PL (illustration omitted) extending through a rear edge of the own vehicle along a vehicle width direction”. The TTC can be calculated based on target information. When the TTC of the solid object is equal to or less than a predetermined time threshold TTCth, the ECU 10 determines that the solid object may hinder safe getting-off action of the occupant, which involves opening the left side door 21, and detects the solid object as an obstruction to the left side door 21.

The ECU 10 performs the same processing when a solid object is present in the first right side region Rra shown in FIG. 2. Specifically, when the TTC of the solid object is equal to or less than the predetermined time threshold TTCth, the ECU 10 determines that the solid object may hinder safe getting-off action of the occupant, which involves opening the right side door 21, and detects the solid object as “an obstruction to the right side door 21”.

When a solid object is present in the second left side region Rlb shown in FIG. 2, the ECU 10 determines that the presence of the solid object on the left lateral side of the own vehicle may hinder the safe getting-off action of the occupant, and detects the solid object as the obstruction. Similarly, when a solid object is present in the second right side region Rrb shown in FIG. 2, the ECU 10 determines that the presence of the solid object on the right lateral side of the own vehicle may hinder the safe getting-off action of the occupant, and detects the solid object as the obstruction. As is clear from the above description, the obstruction detected from one of the first left side region Rla and the first right side region Rra is a moving object approaching from the rear lateral side of the own vehicle, and the obstruction detected from one of the second left side region Rlb and the second right side region Rrb is a moving object or a stationary object present on the lateral side of the own vehicle.

Specific Operation

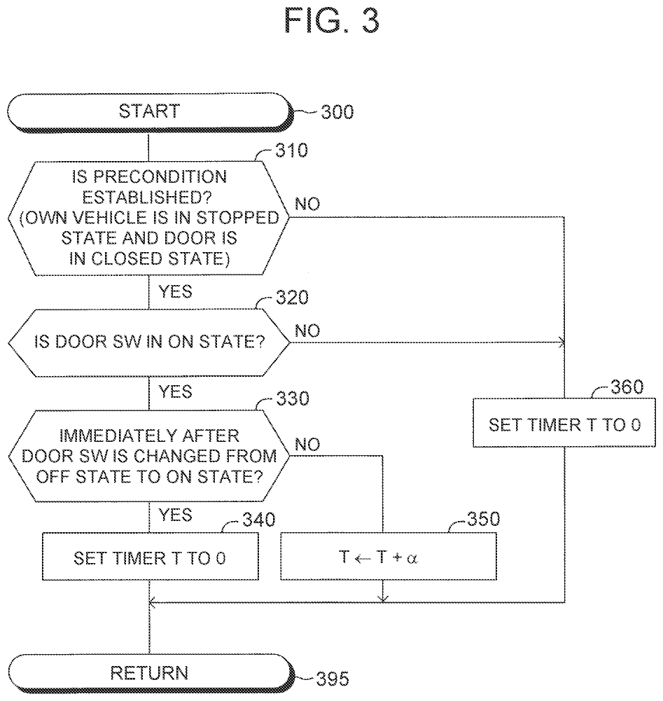

Description is now given of the specific operation of the CPU of the ECU 10. To simplify the description, the operation of the “front right door”, among the doors 21, will be described. Therefore, in the following description, the door SW 14 refers to the door SW 14 for the front right door, and an obstruction refers to an obstruction to the front right door. When it is determined that the own vehicle is in a stopped state, the CPU is configured to repeatedly execute routines shown in the flowchart of FIGS. 3 to 5 whenever prescribed time elapses. The CPU executes these routines independently for every door 21. Note that description of processing regarding alerts will be omitted below. Pressing Continuation Time (Long Pressing Time) Counting Timer

At specified timing, the CPU starts processing in step 300 of FIG. 3, and proceeds to step 310 to determine whether or not a precondition is established. For example, the precondition is established when the own vehicle is in the stopped state and the door 21 is in the closed state.

When the precondition is established, the CPU determines “Yes” in step 310, and proceeds to step 320 to determine whether or not the door SW 14 is in an ON state. When an occupant presses the door SW 14 (when the door SW 14 is in the ON state), the CPU determines “Yes” in step 320 and proceeds to step 330 to determine whether or not the current point of time is immediately after “the point of time when the door SW 14 is changed from the OFF state to the ON state”. When the current point of time is immediately after “the point of time when the door SW14 is changed from the OFF state to the ON state”, the CPU determines “Yes” in step 330, and proceeds to step 340 to set the value of timer T to “0.” Then, the CPU proceeds to step 395, where the present routine is temporarily ended. In contrast, when the current point of time is not immediately after “the point of time when the door SW 14 is changed from the OFF state to the ON state”, the CPU determines “No” in step 330 and proceeds to step 350 to increment the value of timer T by a prescribed value α. Then, the CPU proceeds to step 395.

When the precondition is not established, the CPU determines “No” in step 310, and proceeds to step 360 to set the value of timer T to “0.” Then, the CPU proceeds to step 395. Furthermore, when the door SW 14 is in the OFF state, the CPU determines “No” in step 320, and proceeds to step 395 via step 360. As a result, the value of the value of timer T is calculated as a value representing the pressing continuation time T during the period when the precondition is established.

Operation Change Flag

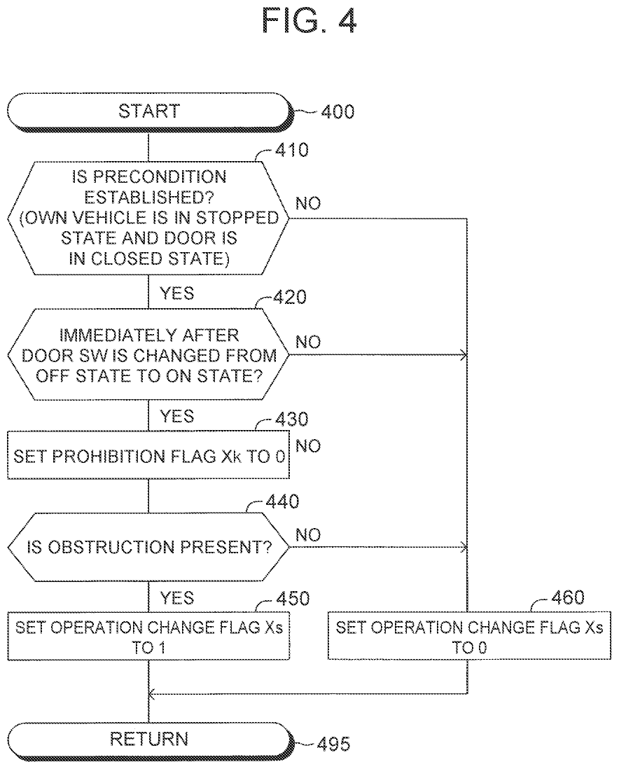

At specified timing, the CPU starts processing in step 400 of FIG. 4, and proceeds to step 410 to determine whether or not the precondition is established.

When the precondition is established, the CPU determines “Yes” in step 410, and proceeds to step 420 to determine whether or not the current point of time is immediately after “the point of time when the door SW 14 is changed from the OFF state to the ON state”. When the current point of time is immediately after “the point of time when the door SW 14 is changed from the OFF state to the ON state”, the CPU determines “Yes” in step 420, and proceeds to step 430 to set the value of a prohibition flag Xk to “0.” As will be described later, the prohibition flag Xk is used to determine whether or not to prohibit switching of the door 21 to the open state when the pressing continuation time T reaches the first time T1.

Next, the CPU proceeds to step 440 to determine whether or not an obstruction is present (i.e. whether or not an obstruction is detected). When an obstruction is detected, the CPU determines “Yes” in step 440, and proceeds to step 450 to set the value of an operation change flag Xs to “1.” Then, the CPU proceeds to step 495, where the present routine is temporarily ended. Contrary to this, when an obstruction is not detected, the CPU determines “No” in step 440, and proceeds to step 460 to set the value of the operation change flag Xs to “0.” Then, the CPU proceeds to step 495. As described above, the operation change flag Xs is a flag indicating whether or not an obstruction is detected at the pressing start point of time. Note that when determining “No” in one of the steps 410 and 420, the CPU proceeds to step 495 via step 460.

Door Opening Control

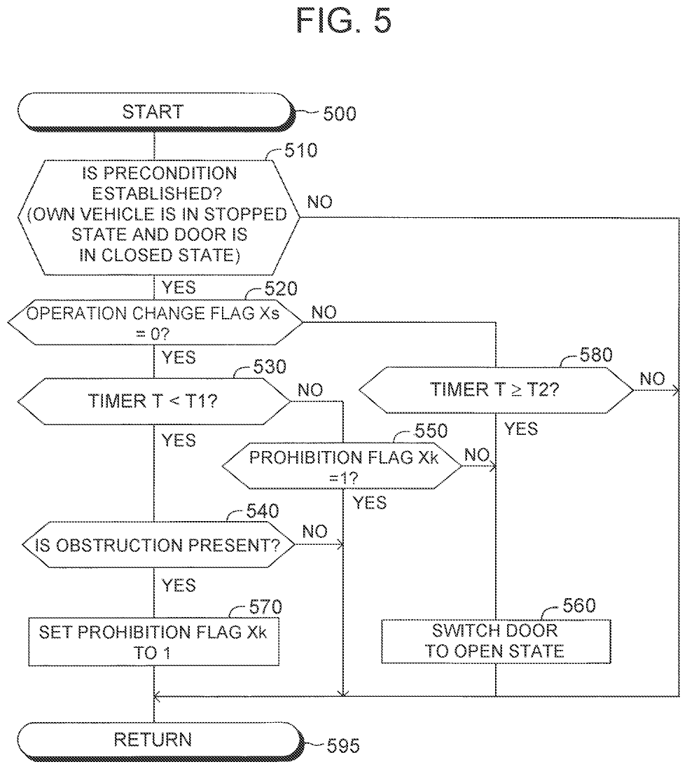

At specified timing, the CPU starts processing in step 500 of FIG. 5, and proceeds to step 510 to determine whether or not the precondition is established. When the precondition is established, the CPU determines “Yes” in step 510, and proceeds to step 520 to determine whether or not the value of operation change flag Xs is “0”.

When the value of the operation change flag Xs is “0” (i.e., when an obstruction is not detected at the pressing start point of time), the CPU determines “Yes” in step 520, and proceeds to step 530 to determine whether or not the value of timer T is less than the first time T1.

When the current point of time is immediately after “the point of time when the door SW14 is changed from the OFF state to the ON state”, the value of the timer T is less than the first time T1. Hence, the CPU determines “Yes” in step 530, and proceeds to step 540. In step 540, the CPU determines whether or not an obstruction is present. When an obstruction is not present, the CPU determines “No” in step 540, and directly proceed to step 595, where the present routine is temporarily ended.

When the state (the door SW 14 is kept in the ON state and no obstruction is detected) continues, the value of the timer T reaches the first time T1 while the value of the prohibition flag Xk is kept to “0”. In this case, when the CPU proceeds to step 530, the CPU determines “No” in step 530, and proceeds to step 550 to determine whether or not the value of the prohibition flag Xk is “1.” At this point, the prohibition flag Xk has a value of “0”, and therefore the CPU determines “No” in step 550, and proceeds to step 560 to switch the door 21 from the closed state to the open state. Then, the CPU proceeds to step 595.

Contrary to this, when the obstruction is detected before the value of the timer T reaches the first time T1, the CPU determines “Yes” in step 540, and proceeds to step 570 to set the value of the prohibition flag Xk to “1.” Then, the CPU proceeds to 595.

In that case, when the value of the timer T reaches the first time T1, the CPU determines “Yes” in step 550, and proceeds to step 595. In other words, when the value of the timer T reaches the first time T1, the CPU does not proceed to step 560. Hence, the door 21 is kept in the closed state. In this case, when the door SW 14 is changed from the ON state to the OFF state, and then again changed to the ON state, the value of the prohibition flag Xk is returned to “0” in step 430 in FIG. 4 described before.

Meanwhile, when the value of the operation change flag Xs is “1” (i.e., when the obstruction is detected at the pressing start point of time), the CPU determines “No” in step 520, and proceeds to step 580. In step 580, the CPU determines whether or not the value of the timer T is equal to or more than “the second time T2 that is longer than the first time T1”. When the value of the timer T is less than the second time T2, the CPU determines “No” in step 580, and proceeds to step 595. Contrary to this, when the value of the timer T reaches the second time T2, the CPU determines “Yes” in step 580, and proceeds to step 560 to switch the door 21 from the closed state to the open state. Thus, when the obstruction is detected at the pressing start point of time, and the value of the timer T reaches the second time T2, the door 21 is switched from the closed state to the open state regardless of whether the obstruction is present or not.

When the ignition is switched on, and also even after the ignition switch is changed from ON to OFF, the CPU is configured to execute the above routines until the predetermined condition (described later) is established. This means that even after the ignition switch is changed to OFF, the ECU 10 receives electric power until the above condition is established. The electric power is also supplied to the sensors and switches 12 to 14 and elements (devices) 30 to 33. When the ignition is switched on, the CPU determines whether or not the own vehicle is in a stopped state based on a signal from the vehicle speed sensor 11. When the ignition is switched off, the CPU determines that the own vehicle is in the stopped state. It is desirable that the above condition is established when it can be estimated that all the occupants have gotten off the own vehicle. The getting-off of the occupants can be estimated by a well-known method (for example, an in-vehicle camera or a weight sensor incorporated into seats).

As described in the foregoing, in the device of the present embodiment, when an obstruction is detected at the point of time (pressing start point of time) when an occupant starts to press the door SW 14 while the vehicle is stationary, the corresponding door 21 is switched from the closed state to the open state at the second point of time when the pressing continuation time T reaches the second time T2. Meanwhile, in the case where, while an obstruction is not detected at the pressing start point of time, the obstruction is detected during the period (first period) until the pressing continuation time T reaches the first point of time, the corresponding door 21 is kept in the closed regardless of the pressing continuation time T. According to the configuration, the pressing continuation time T of the door SW 14 necessary for getting off is one of the first time T1 and the second time T2. Therefore, “the period from the pressing start point of time to the point of time when the door 21 opens (switched to the open state)” no longer varies, so that the occupant can open the door 21 without feeling discomfort.

While the door control device according to the present embodiment has been described in the foregoing, the present disclosure is not limited to the embodiment disclosed, and various modifications are possible without departing from the object of the present disclosure.

For example, inside handles may be provided in place of the door SWs 14. In this case, the inside handles may each be configured as follows. That is, when an occupant grasps an inside handle and applies tension force thereto, a sensor connected to the inside handle generates an ON signal. When the occupant does not grasp the inside handle or applies insufficient tension force, the sensor generates an OFF signal.

Alternatively, the door SWs 14 may be replaced with touch-type handles incorporating an electrostatic capacitance sensor. When an occupant touches the handle, the capacitance detected by the electrostatic capacitance sensor changes. The electrostatic capacitance sensor may be configured to generate an ON or OFF signal based on the change in capacitance.

In addition, the doors 21 may be non-swing doors (typically sliding doors). In this case, when the door SW 14 continues to be pressed for the first time T1, the ECU 10 may be configured to drive the motor 20 and slide the door 21 enough to allow an occupant to get off.

Furthermore, in the embodiment, when the door SW 14 continues to be pressed for the first time T1 while the door 21 is in a locked state, the door 21 is switched to an unlocked state, and then switched to the open state. However, the doors 21 are not limited to this configuration. For example, the doors 21 may be configured as follows. That is, when the door SW 14 is pressed once while the door 21 is in the locked state, the door 21 is switched to the unlocked state. Then, when the door SW 14 continues to be pressed for the first time T1, the door 21 may be switched to the open state. Alternatively, a first switch that switches the door 21 between the locked state and the unlocked state may be provided independently of a second switch that switches the door 21 between the closed state and the open state. In this case, the doors 21 may be configured as follows. That is, when the first switch is pressed once while the corresponding door 21 is in the locked state, the door 21 is switched to the unlocked state. Then, when the second switch continues to be pressed for the first time T1, the door 21 is switched to the open state.

What is claimed is:

1. A door control device comprising:
a sensor device configured to acquire information about a target that is present around a vehicle as target information;
a door operation unit disposed inside the vehicle and configured to be operated by an occupant of the vehicle when the occupant changes a door of the vehicle from a closed state to an open state;
an actuator configured to be able to change the door of the vehicle from the closed state to the open state; and
a control unit configured to drive the actuator in accordance with the target information and an operation state of the door operation unit to change the door from the closed state to the open state, wherein:
the control unit is configured to determine, based on the target information, whether or not an obstruction that may hinder safe getting-off action of the occupant is detected;
when it is determined that the obstruction is not detected at a point of time when operation of the door operation unit is detected while the vehicle is stationary, and when it is not determined that the obstruction is detected during a first period from an operation start point of time of the door operation unit to a first point of time when operation continuation time that is time for continuing the operation reaches a prescribed first time, the control unit is configured to drive the actuator such that the door is kept in the closed state until the first point of time, and the door is changed from the closed state to the open state at the first point of time;
when it is determined that the obstruction is detected during the first period, the control unit is configured to keep the door in the closed state regardless of the operation continuation time; and
when it is determined that the obstruction is detected at the point of time when operation of the door operation unit is detected while the vehicle is stationary, the control unit is configured to drive the actuator such that the door is kept in the closed state during a second period from the operation start point of time of the door operation unit to a second point of time when the operation continuation time reaches a second time that is longer than the first time, and the door is changed from the closed state to the open state at the second point of time.

2. The door control device according to claim 1, wherein the sensor device is configured to acquire information about a target approaching from a rear lateral side of the vehicle and a target present on a lateral side of the vehicle.
